(19) United States
(12) Patent Application Publication
(10) Pub. No.: US 2011/0260967 A1
(43) Pub. Date: Oct. 27, 2011

(54) HEAD MOUNTED DISPLAY

(75) Inventor: Mika MATSUSHIMA, Ichinomiya-shi (JP)

(73) Assignee: BROTHER KOGYO KABUSHIKI KAISHA, Nagoya-shi (JP)

(21) Appl. No.: 13/178,234

(22) Filed: Jul. 7, 2011

Related U.S. Application Data
(63) Continuation-in-part of application No. PCT/JP2010/050176, filed on Jan. 8, 2010.

(30) Foreign Application Priority Data
Jan. 16, 2009 (JP) 2009-007612

(51) Int. Cl. G06F 3/01

(52) U.S. Cl. 345/156

(57) ABSTRACT

In a head mounted display, when it is determined that a hand of a user is in a field angle, the head mounted display starts the playing of main manual information. When a standard time elapses after starting the playing of the main manual information without the determination that the hand of the user is not included in the field angle, the playing of the main manual information is switched to the playing of sub manual information. When it is determined that the hand of the user is not included in the field angle in a state where the playing of the main manual or the sub manual is underway, the playing of the main manual information or the sub manual operation underway is finished.

### CROSS-REFERENCE TO RELATED APPLICATIONS

The present application is a Continuation-in-Part of the International Application PCT/JP2010/050176 filed on Jan. 8, 2010, which claims the benefits of Japanese Patent Application No. 2009-007612 filed on Jan. 16, 2009.

### BACKGROUND

1. Field of the Disclosure

One or more aspects of the disclosure relate to a see-through-type head mounted display.

2. Description of the Related Art

Conventionally, there has been known an information processing device which includes a memory unit which stores various content information such as moving image files, still image files or text files, and a reproducing unit which reproduces the content information stored in the memory unit. As a typical example of the information processing device, a personal computer is known. In general, the personal computer may constituted of a computer body which includes the above-mentioned memory unit, the above-mentioned reproducing unit and the like, a mechanical manipulation unit such as a keyboard or a mouse which a user manipulates to make the computer body perform predetermined operations, a display which displays content information played by the reproducing unit as an image and the like. As a display which displays such display information, a display device which is used in a state where the display device is placed on a desk such as a CRT (Cathode Ray Tube) display or a liquid crystal display is known in general. However, recently, there has been developed head mounted display (hereinafter also referred to as “HMD”) or the like which uses a liquid crystal display element or the like as an image display device and allows a user to visually recognize an image in a state where the user wears the head mounted display on his head.

With respect to the HMD, there has been known a see-through-type HMD which also allows an external light to pass therethrough. The see-through-type HMD is configured to allow a user to visually recognize an external field while allowing the user to visually recognize content information even in the midst of displaying content information as an image. There has been also known an HMD which shows a content of operation to be applied to an operation object to a user. In the HMD, in accordance with the order of respective operation steps, to an operation object per se which is visually recognized by the user, an animation image which is created in advance imitating the operation object in each operation step is displayed in an overlapping manner with the operation object.

### SUMMARY

However, the above-mentioned HMD simply offers an operation support manual. Accordingly, the HMD does not offer a manual corresponding to the level of operation skill of a user such as an operation speed of the user; an operation may not be carried out efficiently. One or more aspects of the disclosure are to provide an HMD which allows a user to efficiently perform an operation by offering manual information corresponding to the level of operation skill of the user to the user.

According to one aspect of the disclosure, there is provided a head mounted display which includes: a display part configured to project an image light corresponding to display information on an eye of a user thus allowing the user to visually recognize the image corresponding to the image light while allowing an external light to pass therethrough; a memory part configured to store first information, a standard time and second information, the standard time and the second information being associated with the first information respectively; an imaging part configured to image at least a portion of a field-of-view range of the user; and a processor accessing a memory to execute instructions that effect: an image analyzing unit configured to analyze an image imaged by the imaging part; a hand detection determination unit configured to determine whether or not a hand of the user is included in a field angle of the imaging part based on a result of an analysis carried out by the image analyzing unit; a display starting unit configured to allow the display part to start playing of the first information stored in the memory part when the hand detection determination unit determines that the hand of the user is included in the field angle; a display switching unit configured to switch the playing of the first information to playing of the second information associated with the first information when the hand detection determination unit determines that the hand of the user is included in the field angle and the standard time associated with the first information elapses from a point of time that the playing of the first information is started by the display part; and a display finishing unit configured to finish the playing of the first information or the second information which are played when the first information or the second information is played by the display part and the hand detection determination unit determines that the hand of the user is not included in the field angle.

According to another aspect of the disclosure, there is provided a method of displaying information by a head mounted display, the method including the steps of: an imaging step imaging at least a portion of a field-of-view range of a user; an analyzing step analyzing an image imaged in the imaging step; an determination step determining whether or not a hand of a user is in the image based on a result of analysis in the image analyzing step; a display starting step starting the playing of first information on a display part when it is determined that the hand of the user is included in the image in the determination step, the display part allows a user to visually recognize an image corresponding to an image light by projecting the image light corresponding to the display information to an eye of a user while allowing the transmission of an external light therethrough, the first information is stored in a memory part which stores the first information, a standard time and a second information, the standard time and the second information being associated with the first information; a switching step switching the playing of the first information to the playing of the second information associated with the first information undergoing the playing when it is not determined that the hand of the user is not in the image in the determination step and the standard time associated with the first information undergoing the playing elapses after starting the playing of the first information in the display starting step; and a finishing step finishing the playing of the played first and second information undergoing the playing when it is determined that the hand of the user is not in the image in the determination step in a case where the first information or the second information is played in the display starting step or the switching step.

### BRIEF DESCRIPTION OF THE DRAWINGS

For a more complete understanding of the disclosure, the needs satisfied thereby, and the objects, features, and advantages thereof, reference now is made to the following description taken in connection with the accompanying drawings.

FIG. 1 is an explanatory view showing an HMD according to one embodiment of this disclosure;

FIG. 2 is an appearance view showing the HMD according to one embodiment of this disclosure;

FIG. 3A is an explanatory view showing a display screen of the HMD according to one embodiment of this disclosure;

FIG. 3B is an explanatory view showing a display screen of the HMD according to one embodiment of this disclosure;

FIG. 4 is an explanatory view showing the electric constitution of the HMD according to one embodiment of this disclosure;

FIG. 5 is an explanatory view showing an operation standard time table for the HMD according to one embodiment of this disclosure;

FIG. 6 is an explanatory view showing the functional constitution of the HMD according to one embodiment of this disclosure;

FIG. 7 is a flowchart showing one example of process executed at the time of performing a control with respect to the HMD;

FIG. 8A is a flowchart showing one example of process executed at the time of performing a control with respect to the HMD;

FIG. 8B is a flowchart showing one example of process executed at the time of performing a control with respect to the HMD;

FIG. 9A is a flowchart showing one example of process executed at the time of performing a control with respect to the HMD; and

FIG. 9B is a flowchart showing one example of process executed at the time of performing a control with respect to the HMD.

### DETAILED DESCRIPTION

Hereinafter, one embodiment of the disclosure is specifically explained in conjunction with drawings. It is noted that various connections are set forth between elements in the following description. It is noted that these connections in general and, unless specified otherwise, may be direct or indirect and that this specification is not intended to be limiting in this respect.

[Appearance of HMD]

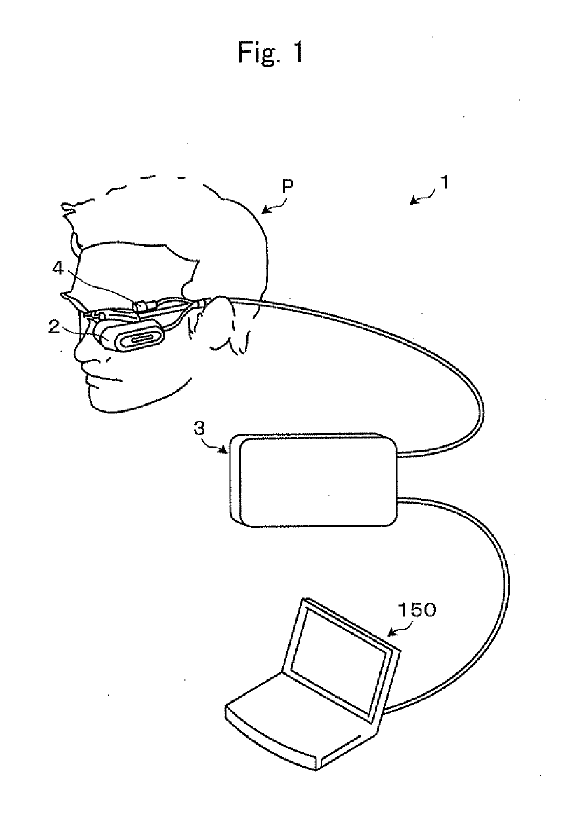

As shown in FIG. 1, an HMD 1 according to this embodiment includes an HMD body 2, a controller 3, a CCD (Charge Coupled device) camera 4 and a personal computer (hereinafter referred to as “PC”) 150 which is communicable with the controller 3. The HMD body 2 displays in a state where a user P wears the HMD body 2 on his head, various content information such as a moving image file, a still image file and a text file, and manual information relating to operations described later as an image so that the user P can visually recognize the image. The controller 3 mainly performs process of supplying image signals to the HMD body 2. The CCD camera 4 images at least a portion of a field-of-view range of the user P.

The HMD body 2 is a retinal imaging display which allows the user P to visually recognize an image corresponding to content information (hereinafter simply referred to as “content”) by scanning light whose intensity is modulated for respective colors (R, G, B) (hereinafter referred to as “image light”) two-dimensionally on a retina of the user P.

In this embodiment, the retinal imaging display is adopted as the HMD body 2. However, the HMD body 2 is not limited to the retinal imaging display. For example, as the HMD body 2, a display which allows the user P to visually recognize content by irradiating light which is formed by the transmission through a LCD (Liquid Crystal Display), the reflection on the LCD (image light), the emission from an OEL (Organic ElectroLuminescent) or the like to an eye of the user P may be adopted.

The HMD body 2 is configured to allow the user to visually recognize an external field within the field-of-view range of the user P in the midst of the display of the content.

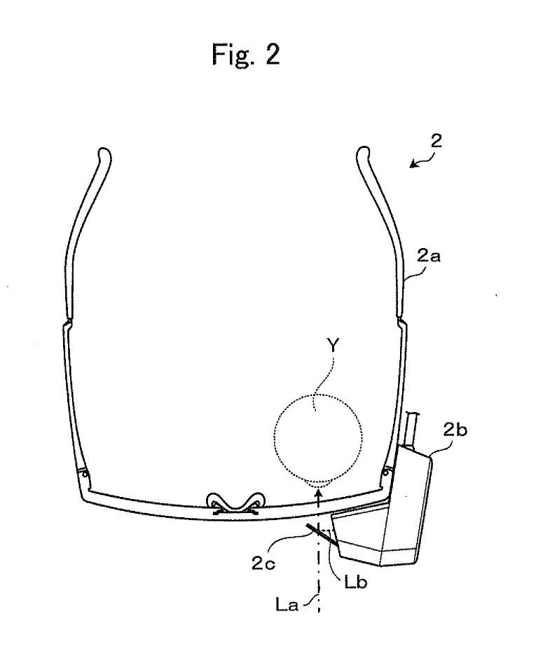

The HMD body 2 includes, as shown in FIG. 2, a support member 2a having an approximately eyeglass shape, and an image forming part 2b for forming an image which is visually recognized by the user P. The image forming part 2b is provided with a half mirror 2c which is arranged in front of an eye of the user P. In the image forming part 2b, an external light La passes through the half mirror 2c and is incident on the eye Y of the user P, while an image light Lb corresponding to content information is reflected on the half mirror 2c and is incident on the eye Y of the user P. In this manner, the HMD 1 is a see-through-type HMD which projects the image light corresponding to content information to the eye Y of the user P while allowing the external light to pass therethrough.

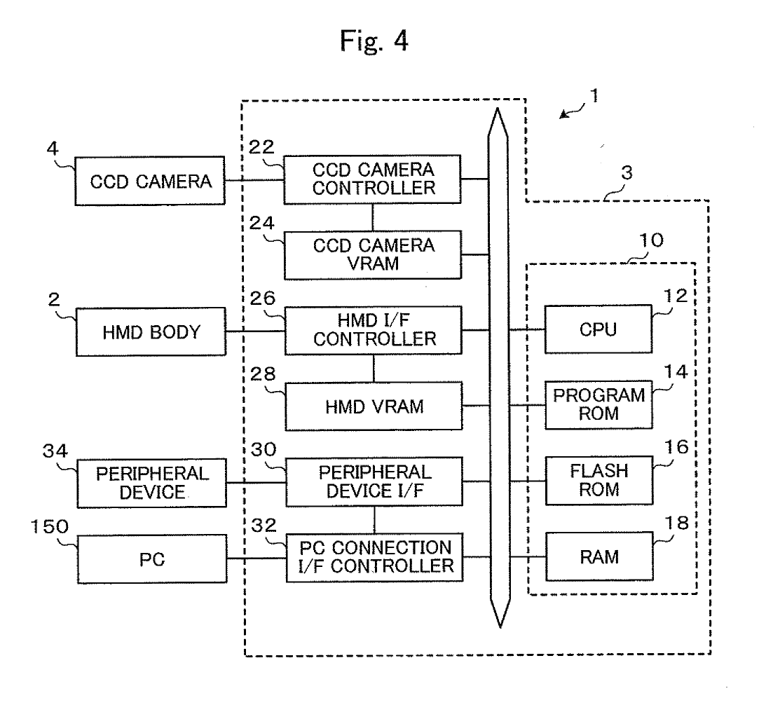

The controller 3 is communicably connected with the HMD body 2, the CCD camera 4, the PC 150 and the like. A control part 10 described later which controls the whole HMD 1 (see FIG. 4) and the like are incorporated in the controller 3.

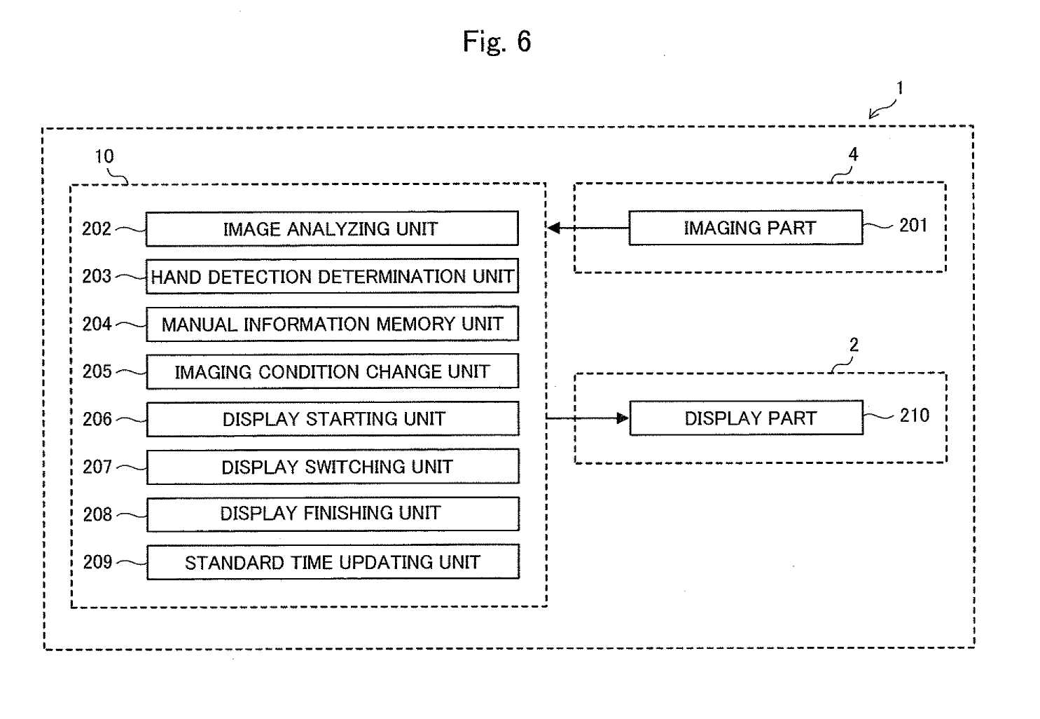

The CCD camera 4 functions as an imaging part 201 which images at least a portion of a field-of-view range of the user P such that a hand of the user P within the field-of-view range of the user P can be detected (see FIG. 6). The CCD camera 4 is configured to sample an image within the field-of-view range of the user P. The CCD camera 4 also has a zoom function so that an imaging range can be changed.

In such a constitution, the HMD 1 according to this embodiment stores display information for performing a display using the HMD body 2. One example of the display information is information relating to an operation which the user performs. The information relating to the operation may include manual information such as the explanation of content and order of the operation, and an image containing the manner of operation, for example. When a hand of the user P enters at least a portion of the field-of-view range of the user P, this state is estimated as a state where the operation is underway. Accordingly, the HMD 1 can reproduce or create the manual information relating to the operation. Further, the HMD 1 is the see-through-type HMD and hence, the user P can visually recognize the manual information relating to the operation while visually recognizing an external field.

The manual information contains main manual information as an example of first information, sub manual information as an example of second information, a manual start time still image, and a manual finish time still image. The manual information is set for every operation.

The main manual information is moving image information which is played from a point of time that the playing is started. The sub manual information is moving image information which is played in place of the main manual information when the playing is started. The sub manual information is played in place of the main manual information after a standard time set corresponding to the content of an operation elapses, for example. The sub manual information may be information which informs at least a part of the main manual information in detail. In this embodiment, the main manual information is formed of a moving image obtained by imaging a hand of the user P and an area around the hand in a wide imaging range. On the other hand, the sub manual information is formed of a moving image obtained by imaging the hand of the user P and the area around the hand in an imaging range narrower than the imaging range of the main manual (by zooming). The manual start time still image is a still image which is displayed before the operation is started. The manual finish time still image is a still image which is displayed after the operation is finished.

These manual information include existing manual information and created manual information. The existing manual information is stored from a time of initial setting of the HMD 1. The formed manual information is formed based on a result of the actually performed operation. The formed manual information is formed by imaging the hand of the user P who is actually performing the operation and the area of around the hand. In this embodiment, the sub manual information is obtained by imaging in the imaging range narrower than the imaging range of the main manual information and hence, the sub manual information becomes the manual information which is more enlarged and detailed than the main manual information.

[Display Screen]

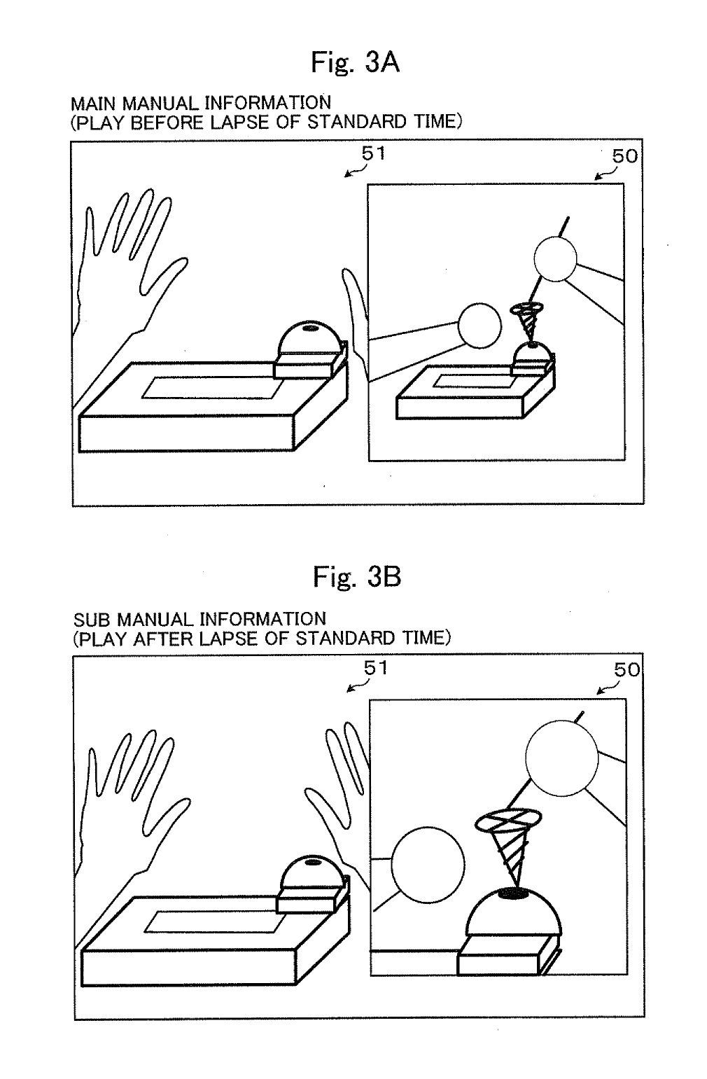

A display screen of the HMD 1 according to this embodiment is explained in conjunction with FIG. 3A and FIG. 3B. Here, although the display screen is an image recognized by a user, the display screen is provided to the user as a virtual image.

As shown in FIG. 3A and FIG. 3B, various manual information is displayed within a display region 50 of the HMD 1. The manual information is a moving image relating to an operation. For example, the manual information is a moving image relating to an assembling operation or a moving image relating to a disassembling operation. Since the HMD 1 is a see-through-type HMD, the user P can visually recognize the manual information shown in FIG. 3A and FIG. 3B while visualizing an external field (scenery showing the operation performed by the user P himself) 51.

The manual information contains the main manual information shown in FIG. 3A and the sub manual information shown in FIG. 3B. When the playing of the main manual information starts, the playing is continued until a standard time set corresponding to the content of the operation elapses. The sub manual information is played after the standard time elapses. The main manual information is, as shown in FIG. 3A, the moving image having a relatively wide imaging range. The sub manual information is, as shown in FIG. 3B, the moving image having a relatively small imaging range, and is displayed in an enlarged manner compared to the moving image of the main manual information. That is, the sub manual information allows the user P to visually recognize finer portions compared to the main manual information.

There may be a case where a user with a low level of operation skill cannot finish an operation even when a standard time elapses. To assist the user with the low level of operation skill, the HMD 1 reproduces not only the main manual information but also the sub manual information displaying the detail of the operation. On the other hand, a user with high level of operation skill finishes an operation before a standard time elapses and hence, the HMD 1 reproduces only the main manual information. Accordingly, the playing of the sub manual information is not specially necessary for the user with a high level of the operation skill. In this manner, the HMD 1 can reproduce manual information corresponding to the level of operation skill, and reproduces the sub manual information which is created by adding improvements on the manual information corresponding to the level of operation skill of the user. Accordingly, the user can efficiently perform the operation.

The HMD 1 of this embodiment can reproduce and create the manual information. Particularly, the HMD 1 can reproduce the manual information relating to an assembling operation of a device. As a method for creating the manual information relating to the assembling operation, a simple method in which a hand of the user P or an area around the hand are imaged at the time of performing an assembling operation and an imaged image is played is named. Further, with the use of the HMD 1, the manual information relating to an assembling operation of a device can be played by imaging a hand of the user P or an area around the hand at the time of performing a disassembling operation of the same device and by reproducing images of the disassembling operation reversely with time. In this manner, by reversely reproducing the manual information imaged by the HMD 1 with time, the user P can efficiently perform the operation without separately having opportunity for imaging.

[Electrical Constitution of HMD]

The electrical constitution and the like of the HMD 1 according to this embodiment are explained in conjunction with FIG. 4.

As shown in FIG. 4, this HMD 1 includes HMD body 2 having the above-mentioned constitution, the controller 3 which controls the HMD body 2 and the like, the CCD camera 4, peripheral devices 34 and a PC 150.

The controller 3 includes a control part 10 which systematically control the operation of the whole HMD 1, a CCD camera controller 22, a CCD camera VRAM 24 and an HMD interface (indicated by “I/F” in the drawing and also referred to as “I/F”) controller 26. Further, the controller 3 includes an HMD VRAM 28, a peripheral device I/F 30 and a PC connection I/F controller 32.

The control part 10 includes a CPU (Central Processing Unit) 12, a program ROM (Read Only Memory) 14 which is a nonvolatile memory, a flash ROM (flash memory) 16 and a RAM (Random Access Memory) 18. These components are connected to a data communication bus respectively, and the transmission and reception of various kinds of information are performed through the data communication bus.

The CPU 12 is a processes or an arithmetic processing unit which operates various kinds of circuits which constitute the HMD 1 as the control part 10. The CPU 12 accesses the RAM 18 to execute various kinds of instructions, e.g., information processing programs stored in the program ROM 14, thus making the circuits execute various kinds of functions which the HMD 1 possesses.

The flash ROM 16 stores an image which the control part 10 images using the CCD camera 4 and images which are supplied from other devices such as the PC 150.

The CCD camera controller 22 controls the CCD camera 4. The CCD camera VRAM 24 temporarily stores the image transmitted from the CCD camera 4. For recognizing a hand of a user P, the control part 10 controls the CCD camera 4 via the CCD camera controller 22, and acquires image data imaged by the CCD camera 4 from the CCD camera VRAM 24. The control part 10 can acquire the image imaged by the CCD camera 4 in this manner, and can recognize the hand of the user P by analyzing the image as described later in detail.

The HMD 1/F controller 26 controls the HMD body 2 in response to a request from the control part 10. The HMD 1/F controller 26 supplies an image signal generated based on the image data stored in the HMD VRAM 28 to the HMD body 2 with the control by the control part 10. In this manner, the control part 10 performs control for displaying an image.

When an image signal is inputted to the HMD body 2 from the HMD 1/F controller 26, the HMD body 2 generates respective signals (signals of three primary colors of R, G, B) which constitute elements for generating an image based on the image signal. Further, the HMD body 2 irradiates laser beams based on the respective generated signals, synthesizes the laser beams, and scans the laser beams two dimensionally. In the HMD body 2, the two-dimensionally scanned laser beams are converted such that center lines of the converted laser beams converge at a pupil of the user P, and are projected on a retina of an eye of the user P. Since the general constitution and the manner of operation of the HMD body 2 are well-known (see JP-A-2007-178941, for example), the specific explanation is omitted here.

The peripheral device I/F 30 is an interface provided for connecting the peripheral devices 34 such as a power source switch, lamps and manipulation devices (not shown in the drawing) to the controller 3. For example, by connecting the power source switch or the lamps to the peripheral device I/F 30, the control part 10 receives manipulation information from the switches such as the power source switch through the peripheral device I/F 30, and supplies lighting information on the lamps to the lamps through the peripheral device I/F 30.

The PC connection I/F controller 32 performs a control such that the controller 3 and the PC 150 are communicable with each other. The control part 10 requests the PC 150 to supply the image data through the PC connection I/F controller 32, and supplies the image data supplied from the PC 150 through the PC connection I/F controller 32 to the HMD body 2. Further, the control part 10 supplies information from the peripheral devices 34 to the PC 150 through the PC connection I/F controller 32.

### [Operation Standard Time Table]

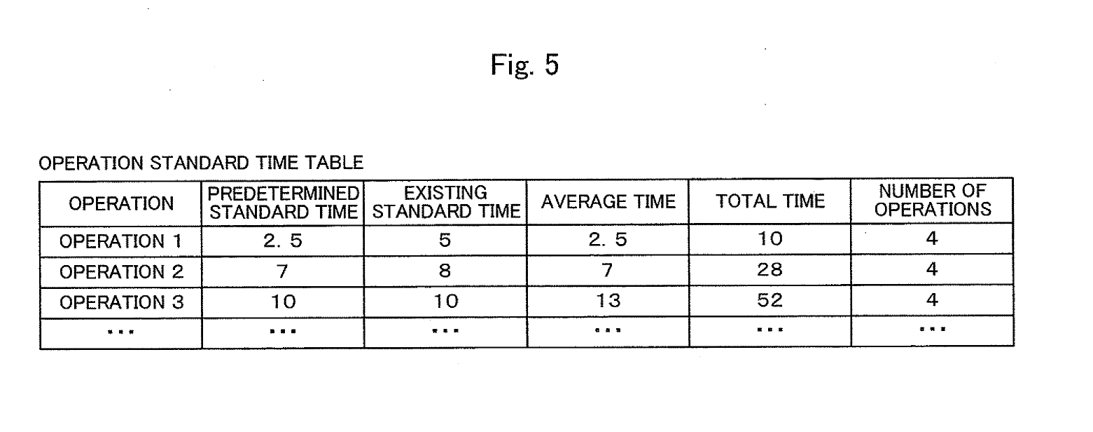

An operation standard time table which is stored in the flash ROM 16 in the HMD 1 having the above-mentioned constitution is explained in conjunction with FIG. 5.

The operation standard time table stored in the flash ROM 16 is a table relating to a standard time. The standard time indicates timings at which main manual information and sub manual information are switched. In the operation standard time table, as shown in FIG. 5, information relating to the standard time is set in an associated manner with respective operations. As the information relating to the standard time, a predetermined standard time, an existing standard time, an average time, a total time, and the number of times of operation are associated with the respective operations. The predetermined standard time is a standard time which is set for every operation, and one of the existing standard time and the average time which is shorter than the other is set as the predetermined standard time. The existing standard time is a standard time which is already set. The average time is a time which is required to finish the operation in average, and is obtained by dividing the total time by the number of times of the operation.

By looking up such an operation standard time table, the control part 10 selects the standard time which is set for every operation. Further, the control part 10 changes the predetermined standard time also corresponding to the average time and hence, a standard time corresponding to an operation of the user can be set. In other words, the flash ROM 16 stores the standard time in such a manner that the standard time is associated with the main manual information and the sub manual information. Here, the flash ROM 16 functions as a manual information storage unit 204 (see FIG. 6) as described later.

Further, the standard time is the time used as a reference for switching the playing of the main manual information and the playing of the sub manual information, and is also the time used as a reference for switching the creation of the main manual information and the creation of the sub manual information. That is, with the use of the operation standard time table, a time for creating the main manual information (predetermined operation time) is set for every operation. In this manner, the flash ROM 16, in which the operation standard time table is stored, stores the predetermined operation time for every operation. In this embodiment, although the standard time is used as the reference for switching both the playing and the creation, the reference for switching is not limited to such a mode. For example, the time which is used as the reference for switching the playing and the time which is used as the reference for switching the creation may differ from each other.

[Functional Constitution of HMD]

Here, the functional constitution and the like of the HMD 1 of this embodiment are explained in conjunction with FIG. 6.

As shown in FIG. 6, the CCD camera 4 of the HMD 1 functions as an imaging part 201 which generates image data by imaging a field-of-view range of the user P, and supplies the image data to the control part 10.

Further, the HMD body 2 which constitutes a part of the HMD 1 functions as a display part 210. The display part 210 projects an image light corresponding to image information (display information) on an eye of the user P thus allowing the user P to visually recognize an image corresponding to the image light while allowing an external light to pass therethrough.

The control part 10 of the HMD 1 functions, since the CPU 12 described later executes a predetermined information processing program, as an image analyzing unit 202, a hand detection determination unit 203, a manual information storing unit 204, an imaging condition changing unit 205, a display starting unit 206, a display switching unit 207, a display finishing unit 208 and a standard time changing unit 209.

The image analyzing unit 202 analyzes the image data imaged by the imaging part 201. Particularly, the image analyzing unit 202 performs the profile detection, the color detection and the like of an image imaged by the imaging part 201 by analyzing the image data outputted from the imaging part 201.

The hand detection determination unit 203 detects a hand of the user P based on the result of an analysis performed by the image analyzing unit 202, and determines whether or not the hand of the user P is included in a field angle (an imaging region) by the imaging part 201.

The above-mentioned CPU 12 and the flash ROM 16 correspond to the manual information storing unit 204. The manual information storing unit 204 stores the main manual information and the sub manual information relating to the operation. Further, the manual information storing unit 204, when the hand detection determination unit 203 determines that the hand of the user P is included in a field angle, stores the image imaged by the imaging part 201 as the main manual information from a point of time that it is determined that the hand of the user is included in the field angle to a point of time that a predetermined operation time elapses. Further, in a case where the hand detection determination unit 203 determines that the hand of the user P is included in the field angle, after the predetermined time elapses from the point of time that it is determined that the hand of the user P is included in the field angle, the manual information storing unit 204 stores an image imaged by the imaging part 201 as the sub manual information. Further, the manual information storing unit 204 stores the main manual information, the sub manual information, and the standard times associated with the main manual information and the sub manual information. The manual information storing unit 204 also stores a predetermined operation time for every operation. Here, the manual information storing unit 204 may be provided in a form that the CPU 12 is communicated with the external PC 150 through the PC connection I/F controller 32.

The imaging condition changing unit 205 changes an imaging condition of the imaging part 201 between a case where the manual information storing unit 204 stores the main manual information and a case where the manual information storing unit 204 stores the sub manual information. To be more specific, the imaging condition changing unit 205 changes the imaging condition such that, in imaging, an imaging range at the time of storing the sub manual information becomes narrower than an imaging range at the time of storing the main manual information.

When the hand detection determination unit 203 determines that the hand of the user P is included in the field angle, the display starting unit 206 allows the display part 210 to start the playing of the main manual information which is stored in the manual information storing unit 204.

When the hand detection determination unit 203 determines that the hand of the user is not included in the field angle after the playing of the main manual information is started by the display part 210 and the standard time which is associated with the main manual information undergoing the playing elapses, the display switching unit 207 switches the playing of the main manual information to the playing of the sub manual information.

In a case where the main manual information or the sub manual information is played by the display part 210, when the hand detection determination unit 203 determines that the hand of the user is not included in the field angle, the display finishing unit 208 finishes the playing of the main manual information or the sub manual information undergoing the playing.

When a time from starting of the playing of the main manual information by the display part 210 to the determination that the hand of the user is not included in the field angle by the hand detection determination unit 203 is not more than the standard time, the standard time changing unit 209 changes the standard time based on the time.

[Control Operation]

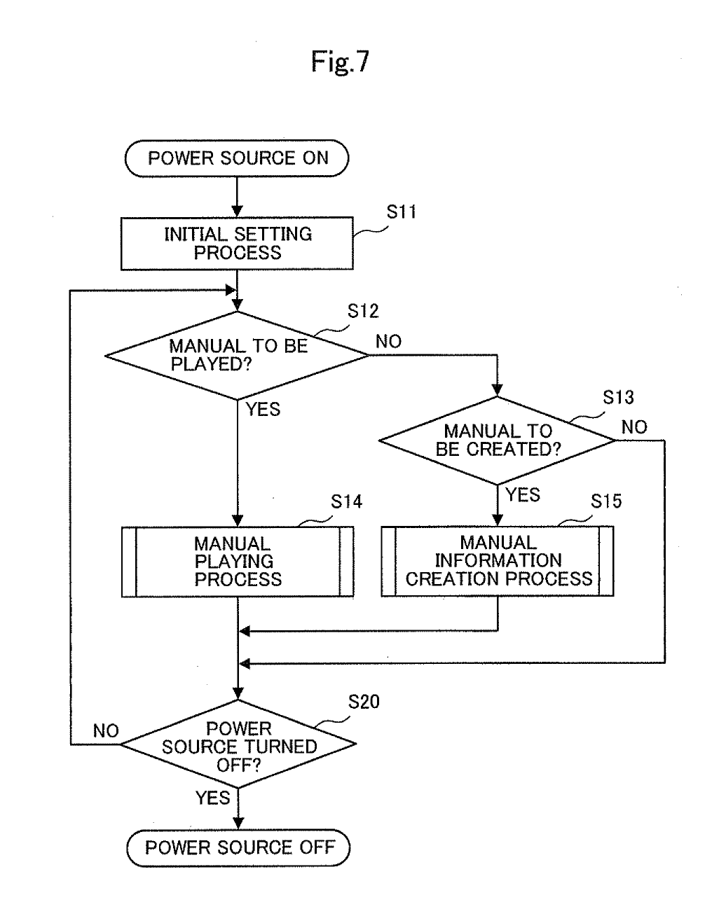

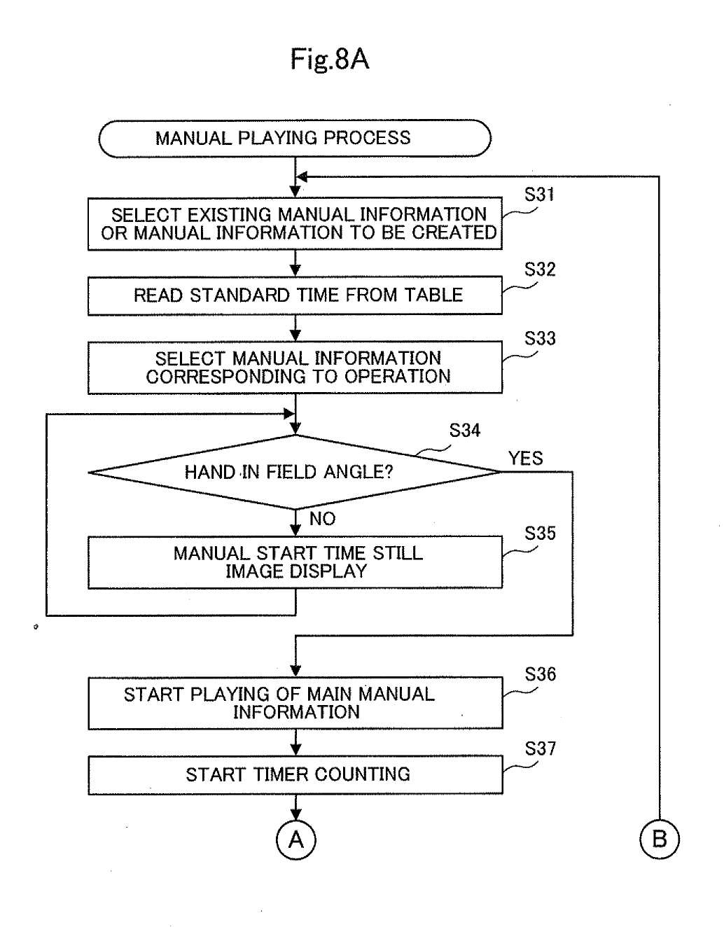

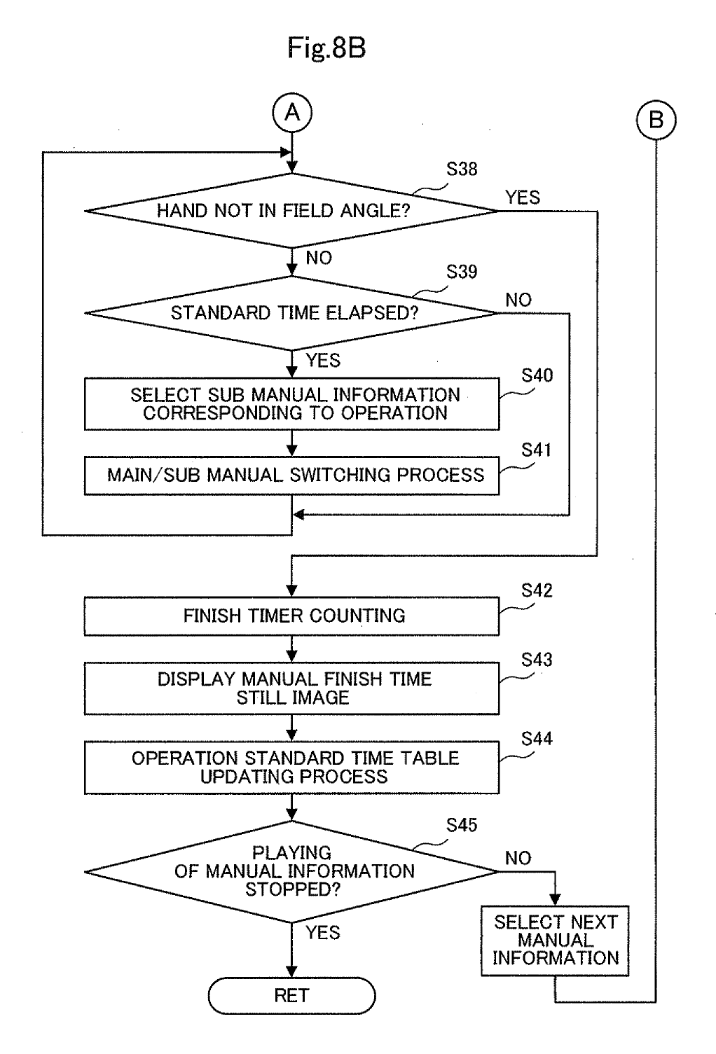

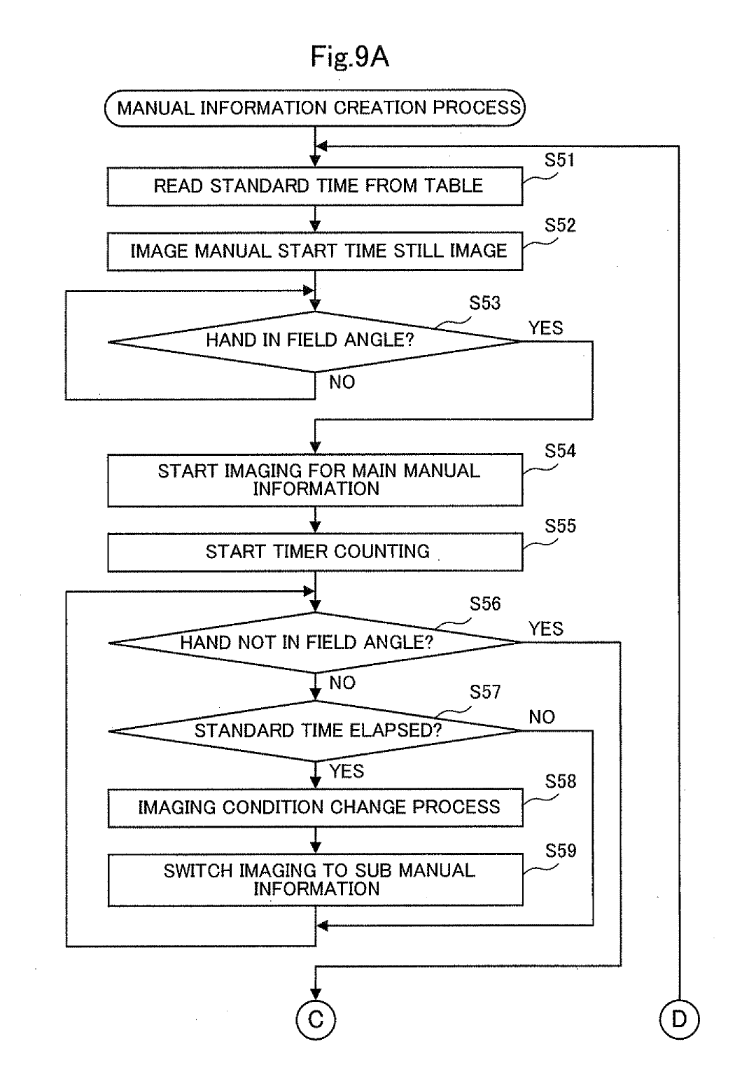

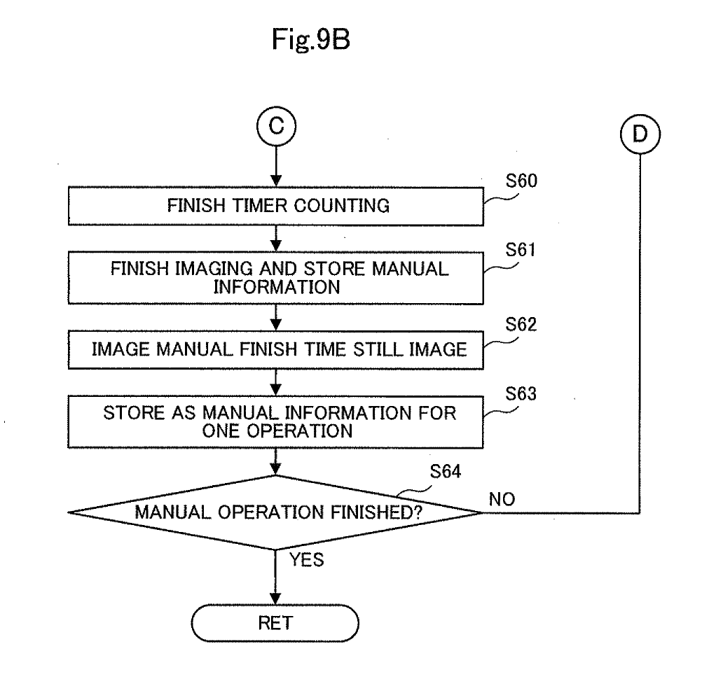

Next, the manner of operation of the HMD 1 is explained in conjunction with flowcharts of FIG. 7, FIG. 8A, FIG. 8B and FIG. 9. Particularly, main process shown in FIG. 7 is executed by the control part 10 of the controller 3 when a power source of the HMD 1 is turned on. Since the control part 10 of the controller 3 executes the main process, the control part 10 functions as the above-mentioned respective units.

[Main Process]

Firstly, as shown in FIG. 7, when electricity is supplied to the HMD 1, the control part 10 executes the initial setting (step S11). In this process, the control part 10 executes RAM access permission, initialization of a work area and the like. Further, the control part 10 performs a display control such that the control part 10 starts the HMD body 2 and allows the HMD body 2 to display an initial screen and the like. When this process is finished, the control part 10 advances the process to step S12.

In step S12, the control part 10 determines whether or not the manual information is to be played based on the manipulation by the user P. In this process, the control part 10 determines an operation performed corresponding to a manipulation by the user P. As a result, the control part 10 determines whether or not manual information corresponding to the selected operation is to be played.

When the control part 10 determines that the manual information is played (step S12: YES), as described later in detail in conjunction with FIG. 8, the control part 10 executes the manual information reproducing process (step S14), and advances the process to step S20.

On the other hand, when the control part 10 determines that the manual is not played (step S12: NO), the control part 10 determines whether or not the manual information is to be created based on the manipulation by the user P (step S13). In this process, the control part 10 determines the operation performed based on the manipulation by the user P. As a result, the control part 10 determines whether or not the manual information corresponding to the selected operation is to be created.

When the control part 10 determines that the manual information is created (step S13: YES), as described later in detail in conjunction with FIG. 9, the control part 10 executes manual information creation process (step S15), and advances the process to step S20. On the other hand, when the control part 10 determines that the manual information is not created (step S13: NO), the control part 10 advances the process to step S20.

In step S20, the control part 10 determines whether or not the power source is in an OFF state. In this process, the control part 10 determines whether or not the power source is in an OFF state based on the manipulation of the power source switch and the like. When the control part 10 determines that the power source is in an OFF state (step S20: YES), the main process is finished. On the other hand, when the control part 10 determines that the power source is not in an OFF state (step S20: NO), the control part 10 returns the process to step S12. Due to such process, the control part 10 repeatedly executes the above-mentioned process until the power source is turned off.

In this embodiment, the execution of the playing or the creation of the manual information is determined based on the manipulation by the user. However, the determination is not limited to the determination based on the manipulation by the user. For example, the determination may be made such that the control part 10 analyses an image imaged by the CCD camera 4 and, when an identifying object such as a QR code is recognized in the image, the control part 10 selects an operation corresponding to the identifying object, and executes the playing of the manual information corresponding to the operation.

[Manual Information Reproducing Process]

A subroutine which is executed in step S14 shown in FIG. 7 is explained in conjunction with FIG. 8A and FIG. 8B.

Firstly, as shown in FIG. 8A, the control part 10 makes the imaging by the CCD camera 4 valid, and selects existing manual information which is stored in the flash ROM 16 from a point of time of initial setting or manual information which is created in manual information creation process described later based on the manipulation by the user (step S31). When this process is finished, the control part 10 advances the process to step S32.

In step S32, the control part 10 looks up the operation standard time table (see FIG. 5), and reads the predetermined standard time corresponding to the operation. Then, the control part 10 selects the manual information corresponding to such an operation (step S33). When this process is finished, the control part 10 advances the process to S34.

In step S34, the control part 10 determines whether or not the hand of the user P is included in the field angle. In this process, the control part 10 may perform the profile detection and the color detection of image data which is imaged by the CCD camera 4. That is, the control part 10 analyses the image in the field angle imaged by the CCD camera 4. Then, the control part 10 executes process for detecting a profile of the hand of the user P based on a result of the profile detection and the color detection. To be more specific, the control part 10 detects a skin color region contained in the image data, and performs pattern matching between a profile of the skin color region and a template of a profile of the hand which is stored in the flash ROM 16. Then, the control part 10 determines whether or not the hand of the user P is included in the field angle. That is, the control part 10 determines whether or not the hand of the user in the field angle based on the result of the analysis of the image. It is noted, however, that the determination by the control part 10 may be made by various other methods. For example, a predetermined identifier may be adhered to a glove which a user wears on his hand or a tool which the user holds with his hand, and the control part 10 may determine that the hand of the user P is included in the field angle when the predetermined identifier is detected. The predetermined identifier may be a bar-code, a two-dimensional-code or the like. The tool which the user holds with his hand may be an industrial tool or the like.

In this process, when the control part 10 determines that the hand of the user P is included in the field angle (step S34: YES), the control part 10 advances the process to step S36. On the other hand, when the control part 10 determines that the hand of the user P is not included in the field angle (step S34: NO), the control part 10 performs a control for displaying a manual start time still image by the HMD body 2 (step S35), and the process returns to step S34 again. Due to such process, the manual start time still image is displayed by the HMD body 2 until the hand of the user P enters the field angle.

In step S36, the control part 10 reads the main manual information corresponding to the operation from the flash ROM 16, and allows the HMD body 2 to start the playing of the main manual information. Then, the control part 10 allows a timer to start counting (step S37). This timer is provided for measuring a time which elapses from starting of the operation. That is, when the control part 10 determines that the hand of the user P is included in the field angle, the control part 10 allows the HMD body 2 to start the playing of the main manual information, and measures a time from a point of time that the playing of the main manual information is started. When this process is finished, the control part 10 advances the process to step S38.

As shown in FIG. 8B, in step S38, the control part 10 determines whether or not the hand of the user P is not included in the field angle. In this process, the control part 10 determines whether or not the hand of the user P is not included in the field angle by performing the same control as the above-mentioned step S34. That is, the control part 10 analyses an image in the field angle by the CCD camera 4, and determines whether or not the hand of the user P is included in the field angle based on the result of the analysis of the image. When the control part 10 determines that the hand of the user P is not included in the field angle (step S38: YES), the control part 10 recognizes that the operation is finished, and the control part 10 advances the process to step S42. On the other hand, when the control part 10 determines that the hand of the user P is included in the field angle (step S38: NO), the control part 10 recognizes that the operation is not finished, and the control part 10 advances the process to step S39.

In step S39, the control part 10 determines whether or not the standard time elapses. In this process, the control part 10 reads a value from the timer which starts counting in step S37 and determines whether or not the standard time elapses from a point of time that the operation is started. When the control part 10 determines that the standard time elapses (step S39: YES), the control part 10 advances the process to step S40. On the other hand, when the control part 10 determines that the standard time does not elapse (step S39: NO), the control part 10 returns the process to step S38 again without executing the process in step S40 and step S41.

In step S40, the control part 10 selects the sub manual information corresponding to the selected operation. Then, the control part 10 executes main manual/sub manual switching process in which the main manual information undergoing the playing is switched to the sub manual information (step S41).

Due to such process, the control part 10 continues the playing of the main manual information until the standard time elapses from the point of time that the playing of the main manual information is started without the determination that the hand of the user is not included in the field angle. Further, when the standard time elapses from the point of time that the playing of the main manual information is started without the determination that the hand of the user is not included in the field angle, the control part 10 switches the playing of the main manual information underway to the playing of the sub manual information. When this process is finished, the control part 10 advances the process to step S38 again.

On the other hand, in step S42, the control part 10 allows the timer to finish counting, and performs a control for allowing the HMD body 2 to display a manual finish time still image (step S43). Due to such process, in a case where the playing of the main manual information or the sub manual information is underway by the HMD1, when the hand of the user is not included in the field angle, the playing of the main manual information or the sub manual undergoing the playing is finished, and a manual finish time still image is displayed by the HMD body 2. When this process is finished, the control part 10 advances the process to step S44.

In step S44, the control part 10 executes operation standard time table updating process. In this process, the control part 10 reads a value of the timer which finishes counting, and adds the value of the timer to a total time in the operation standard time table thus incrementing the number of times of operation by “1”. The control part 10 also calculates an average time based on the updated total time and the updated number of times of operation, and updates the average time. Then, the control part 10 compares the updated average time with an existing standard time, and updates the time having a smaller value as a predetermined standard time.

Due to such process, the control part 10 updates the standard time based on the time from starting of the playing of the main manual information to the determination that the hand of the user is not included in the field angle. When this process is finished, the control part 10 advances the process to step S45.

In this manner, when the operation does not require so much time, the HMD 1 finishes the playing of the main manual information without performing the playing of the sub manual information. On the other hand, when the operation requires a considerable time, the HMD 1 switches the playing of the main manual information to the playing of the sub manual information. Accordingly, the HMD 1 can offer the manual information corresponding to the level of operation skill of the user and hence, the user can efficiently perform the operation.

In step S45, the control part 10 allows the HMD body 2 to display a standby image indicative of whether next manual information is to be played, and determines whether or not the playing of the manual is finished in response to the manipulation by the user P. In this process, when the control part 10 determines that the playing of the manual information is finished (step S45: YES), the control part 10 makes imaging by the CCD camera 4 invalid, and finishes this subroutine. On the other hand, when the control part 10 determines that the playing of the manual information is not finished (step S45: NO), the control part 10 selects the next manual information (step S46), and returns the process to step S31 again. Accordingly, the control part 10 can continuously reproduce the manual information.

In this manner, the standard time can be updated based on the time during which the user is engaged in the operation, that is, the standard time can be set by referencing the operation in which the user is engaged previously. Accordingly, the HMD 1 can offer the manual information corresponding to the level of operation skill of the user and hence, the user can efficiently perform the operation.

[Manual Information Creation Process]

A subroutine executed in step S15 in FIG. 7 is explained in conjunction with FIG. 9A and FIG. 9B.

Firstly, as shown in FIG. 9A, the control part 10 makes imaging by the CCD camera 4 valid, looks up the operation standard time table (see FIG. 5), and reads a predetermined standard time corresponding to an operation (step S51). Then, the control part 10 stores an image imaged by the CCD camera 4 in the flash ROM 16 as a manual start time still image (step S52). When this process is finished, the control part 10 advances the process to step S53.

In step S53, the control part 10 determines whether or not a hand of the user P is included in the field angle. In this process, the control part 10 determines whether or not the hand of the user P is not included in the field angle by executing the same control in the above-mentioned step S34 and step S38. That is, the control part 10 analyses an image in the field angle obtained by the CCD camera 4, and determines whether or not the hand of the user P is included in the field angle based on a result of the image analysis. In this process, when the control part 10 determines that the hand of the user P is included in the field angle (step S53: YES), the control part 10 advances the process to step S54. On the other hand, when the control part 10 determines that the hand of the user P is not included in the field angle (step S53: NO), the process is returned to step S53 again. Accordingly, the creation of the manual information is held in a standby state until the hand of the user P enters the field angle.

In step S54, the control part 10 starts imaging for forming main manual information. In this process, the control part 10 stores image data imaged by the CCD camera 4 in the flash ROM 16 as the main manual information. Then, the control part 10 starts counting by the timer (step S55). The timer measures a time which elapses from starting of the creation of the main manual information. When this process is finished, the control part 10 advances the process to step S56.

In step S56, the control part 10 determines whether or not the hand of the user P is not included in the field angle. In this process, the control part 10 determines whether or not the hand of the user P is not included in the field angle by executing the same control in the above-mentioned step S34, step S38 and step S53. That is, the control part 10 analyses an image in the field angle obtained by the CCD camera 4, and determines whether or not the hand of the user P is included in the field angle based on a result of the image analysis. When the control part 10 determines that the hand of the user P is not included in the field angle (step S56: YES), the control part 10 recognizes that the operation is finished so that the creation of the manual information is finished, and the control part 10 advances the process to step S60 (see FIG. 9B). On the other hand, when the control part 10 determines that the hand of the user P is included in the field angle (step S56: NO), the control part 10 recognizes that the operation is not finished so that the creation of the manual information is continued, and the control part 10 advances the process to step S57.

In step S57, the control part 10 determines whether or not the standard time elapses. In this process, the control part 10 reads a value from the timer which starts counting in step S55, and determines whether or not the standard time elapses from the starting of the operation (starting of creation). When the control part 10 determines that the standard time elapses (step S57: YES), the control part 10 advances the process to step S58. On the other hand, when the control part 10 determines that the standard time does not elapse (step S57: NO), the control part 10 returns the process to step S56 without executing step S58 and step S59.

In step S58, the control part 10 executes imaging condition change process for changing an imaging condition such as narrowing (zooming) of an imaging range. In this manner, by changing the imaging condition of the CCD camera 4 between the case where the main manual information is stored and the case where the sub manual information is stored, the main manual information and the sub manual information can be differentiated from each other. Particularly, the control part 10 can create the manual information corresponding to the level of operation skill of a user by imaging the sub manual information in more detail than the main manual information, for example.

Then, the control part 10 switches the imaging from the main manual information to the sub manual information (step S59). In this process, before changing the imaging condition, the control part 10 stores image data which has been imaged as the main manual information corresponding to the operation in the flash ROM 16. Then, the control part 10 changes the imaging condition and starts imaging for the sub manual information. The control part 10 stores image data to be imaged as the sub manual information in the flash ROM 16 hereafter.

Accordingly, the control part 10, when the control part 10 determines that the hand of the user in the field angle, stores an imaged image which is imaged until a predetermined operation time elapses from the determination that the hand is included in the field angle as the main manual information, and stores an imaged image which is imaged from a point of time that the predetermined operation time elapses from the determination that the hand is included in the field angle as the sub manual information. When this process is finished, control part 10 returns the process to step S56 again.

On the other hand, as shown in FIG. 9B, in step S60, the control part 10 finishes counting of the timer, finishes imaging for the main manual information or the sub manual information, and stores the main manual information or the sub manual information in the flash ROM 16 (step S61). Accordingly, the control part 10 stores the imaged image as the main manual information or the sub manual information when the control part 10 determines that the hand of the user in the field angle, while the control part 10 finishes imaging for the main manual information or the sub manual information when the control part 10 determines that the hand of the user is not included in the field angle. When this process is finished, the control part 10 advances the process to step S62.

In step S62, the control part 10 stores an image imaged by the CCD camera 4 as a manual finish time still image in the flash ROM 16. When this process is finished, the control part 10 advances the process to step S63.

In step S63, the control part 10 stores the manual start time still image, the main manual information, the sub manual information and the manual finish time still image imaged in the above-mentioned manner in the flash ROM 16 as manual information corresponding to one operation. Accordingly, in the above-mentioned step S31, the control part 10 can select the created manual information other than existing manual information.

Further, the control part 10, in reversing the imaged manual information in a reversed manner with time, stores the imaged manual information in a reversed manner. Accordingly, the control part 10 can reproduce the manual information without being conscious whether or not the manual information is to be reversed. It is needless to say that the control part 10 may store the imaged manual information without reversing, and may reproduce the manual information by reversing at the time of playing. When this process is finished, the control part 10 advances the process to step S64.

In step S64, the control part 10 displays a standby image indicative of whether or not next manual information is to be created, and determines whether or not the creation of the manual is finished in response to a manipulation by the user P. In this process, when the control part 10 determines that the creation of the manual is finished (step S64: YES), the control part 10 makes imaging by the CCD camera 4 invalid, and finishes this subroutine. On the other hand, when the control part 10 determines that the creation of the manual is not finished (step S64: NO), the control part 10 advances the processing to step S51 again. Accordingly, the control part 10 can continuously create the manual information.

In this manner, when the user performs an operation, an imaged image of the operation per se becomes the main manual information or the sub manual information. Accordingly, the user can save time for creating the main manual information or the sub manual information separately and hence, the user can efficiently perform the operation. Further, the HMD 1 can store the main manual information and the sub manual information in a switched manner before and after the lapse of the predetermined operation time. Accordingly, the user can save time for creating the main manual information and the sub manual information separately and hence, the user can efficiently perform the operation. Further, with the use of the HMD 1, a predetermined operation time can be set for every operation and hence, an operation time corresponding to a kind of the operation can be set thus facilitating the operation.

### Other Embodiments

In the above-mentioned embodiment, the control part 10 adopts an image having a wide imaging range (wide angle of view) as the main manual information and an image having a narrow imaging range (narrow angle of view) as the sub manual information. However, the main manual information and the sub manual information are not limited to these images. For example, the main manual information may be formed of an image of a normal speed and the sub manual information may be formed of an image of ½ times speed. Further, for example, the main manual information and the sub manual information may be imaged at different angles. That is, the sub manual information may be recognized as information which is in more detail than the main manual information.

Further, in the HMD 1 of the above-mentioned embodiment, a still image is displayed before the hand of the user P enters an imaging range of the CCD camera 4, and a moving image is displayed as the main manual information and the sub manual information when the hand of the user P enters the imaging range, and when the hand of the user P goes outside from the inside of the imaging range of the CCD camera 4, a still image is displayed. However, the embodiment is not limited to such a display. For example, a moving image may be displayed before the hand of the user P enters an imaging range of the CCD camera 4 or after the hand of the user P goes outside from the inside of the imaging range of the CCD camera 4.

Further, in the above-mentioned embodiment, the control part 10 adopts one of the existing standard time and the average time shorter than the other as the predetermined standard time. However, the predetermined standard time is not limited to such a time. For example, the control part 10 may set an operation time per se of previous time as the predetermined standard time. Further, the control part 10 may adopt the shortest time among operation times of previous times as the predetermined standard time. That is, the control part 10, when the time from starting the playing of the main manual information to the determination that the hand of the user is not included in the field angle is not more than the standard time, updates the standard time based on the time. Further, there is no problem in adopting the constitution where the standard time per se is not updated, for example.

Further, in the above-mentioned embodiment, the HMD body 2, the controller 3 and the PC 150 are separately constituted from each other. However, the HMD is not limited to such constitution. For example, the controller 3 and the PC 150 may be constituted as an integral body or the HMD body 2 and the controller 3 may be constituted as an integral body. It is needless to say that all these parts may be constituted as an integral body or may be constituted as separate bodies.

What is claimed is:

1. A head mounted display comprising:
a display part configured to project an image light corresponding to display information on an eye of a user thus allowing the user to visually recognize the image corresponding to the image light while allowing an external light to pass therethrough;
a memory part configured to store first information, a standard time and second information, the standard time and the second information being associated with the first information respectively;
an imaging part configured to image at least a portion of a field-of-view range of the user; and
a processor accessing a memory to execute instructions that effect:
an image analyzing unit configured to analyze an image imaged by the imaging part;
a hand detection determination unit configured to determine whether or not a hand of the user is included in a field angle of the imaging part based on a result of an analysis carried out by the image analyzing unit;
a display starting unit configured to allow the display part to start playing of the first information stored in the memory part when the hand detection determination unit determines that the hand of the user is included in the field angle;
a display switching unit configured to switch the playing of the first information to playing of the second information associated with the first information when the hand detection determination unit determines that the hand of the user is included in the field angle and the standard time associated with the first information elapses from a point of time that the playing of the first information is started by the display part; and
a display finishing unit configured to finish the playing of the first information or the second information which are played when the first information or the second information is played by the display part and the hand detection determination unit determines that the hand of the user is not included in the field angle.

2. The head mounted display according to claim 1, wherein the processor further executes instructions that effect:
a standard time updating unit configured, when a time from starting of the playing of the first information by the display part to the determination that the hand of the user is not included in the field angle by the hand detection unit is not more than the standard time, to update the standard time based on the time.

3. The head mounted display according to claim 1, wherein the processor is configured, when the hand detection determination unit determines that the hand of the user is included in the field angle, to store the image imaged by the imaging part in the memory part as first information or second information.

4. The head mounted display according to claim 3, wherein the processor is configured, when the hand detection determination unit determines that the hand of the user is included in the field angle, to store the image imaged by the imaging part in the memory part as the first information until a predetermined operation time elapses from the determination that the hand is included in the field angle, and to store the image imaged by the imaging part in the memory part as the second information after a predetermined operation time elapses from the determination that the hand is included in the field angle.

5. The head mounted display according to claim 4, wherein the memory part is configured to store the predetermined operation time for every operation.

6. The head mounted display according to claim 4 wherein the head mounted display includes an imaging condition changing unit which changes an imaging condition of the imaging part between a case where the first information is stored in the memory part and a case where the second information is stored in the memory part.

7. The head mounted display according to claim 1, wherein the memory part stores information which indicates at least a portion of the first information in detail as the second information.

8. The head mounted display according to claim 1, wherein the memory part stores a manual relating to an operation which the user performs as the first information and the second information.

9. A method of displaying information by a head mounted display, the method comprising the steps of:
an imaging step imaging at least a portion of a field-of-view range of a user;
an analyzing step analyzing an image imaged in the imaging step;
an determination step determining whether or not a hand of a user is in the image based on a result of analysis in the image analyzing step;
a display starting step starting the playing of first information on a display part when it is determined that the hand of the user is included in the image in the determination step, the display part allows a user to visually recognize an image corresponding to an image light by projecting the image light corresponding to the display information to an eye of a user while allowing the transmission of an external light therethrough, the first information is stored in a memory part which stores the first information, a standard time and a second information, the standard time and the second information being associated with the first information;
a switching step switching the playing of the first information to the playing of the second information associated with the first information undergoing the playing when it is not determined that the hand of the user is not in the image in the determination step and the standard time associated with the first information undergoing the playing elapses after starting the playing of the first information in the display starting step; and
a finishing step finishing the playing of the played first and second information undergoing the playing when it is determined that the hand of the user is not in the image in the determination step in a case where the first information or the second information is played in the display starting step or the switching step.
